(19) United States
(12) Patent Application Publication
(10) Pub. No.: US 2009/0023609 A1
(43) Pub. Date: Jan. 22, 2009

(54) PROGRAMMABLE MASK FOR FABRICATING BIOMOLECULE ARRAY OR POLYMER ARRAY, APPARATUS FOR FABRICATING BIOMOLECULE ARRAY OR POLYMER ARRAY INCLUDING THE PROGRAMMABLE MASK, AND METHOD OF FABRICATING BIOMOLECULE ARRAY OR POLYMER ARRAY USING THE PROGRAMMABLE MASK AND PHOTOCHEMICAL SYNTHESIS APPARATUS

(76) Inventors: Moon Youn JUNG, Daejeon-city (KR); Dong Ho SHIN, Daejeon-city (KR); Se Ho PARK, Daejeon-city (KR); Hyeon Bong PYO, Daejeon-city (KR); Chi Hoon JUN, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/174,773

(22) Filed: Jul. 17, 2008

Related U.S. Application Data
(63) Continuation-in-part of application No. 11/634,408, filed on Dec. 6, 2006.

(30) Foreign Application Priority Data
Dec. 8, 2005 (KR) 10-2005-0119460
Jun. 22, 2006 (KR) 10-2006-0056528
Nov. 26, 2007 (KR) 10-2007-0120900

(51) Int. Cl. C40B 50/18; C40B 60/14; B01J 19/12

(52) U.S. Cl. 506/32; 506/40; 422/186

(57) ABSTRACT

Provided are a programmable mask for promptly fabricating a biomolecule or polymer array having high density, an apparatus for fabricating a biomolecule or polymer array including the mask, a method of fabricating a biomolecule or polymer array using the programmable mask and a photochemical synthesis apparatus. The programmable mask for fabricating a biomolecule array or polymer array includes a first substrate including a black matrix having openings and first pixel electrodes; a second substrate including thin film transistors for switching pixel regions which correspond to the openings according to applied electric signals and second pixel electrodes connected to drain electrodes of the thin film transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate; a second polarizing plate laminated on one side of the second substrate; and a lens array layer laminated on one side of the second polarizing plate including lenses which correspond to the pixel regions.

### CROSS-REFERENCE TO RELATED PATENT APPLICATION

This application claims the benefit of Korean Patent Application Nos. 10-2005-0119460, filed on Dec. 8, 2005, 10-2006-0056528, filed on Jun. 22, 2006, 10-2007-0120900, filed on Nov. 26, 2007, in the Korean Intellectual Property Office, the disclosure of which is incorporated herein in its entirety by reference.

### BACKGROUND OF THE INVENTION

1. Field of the Invention

The present invention relates to a programmable mask for fabricating a biomolecule array or polymer array, an apparatus for fabricating biomolecule array or polymer array including the programmable mask, a method of fabricating biomolecule array or polymer array using the programmable mask, and a photochemical synthesis apparatus.

2. Description of the Related Art

Research has been conducted on performing various kinds of experiments into one combined experiment using a biomolecule array or polymer array. Examples of a biomolecule array or polymer array include polypeptide, carbohydrate, or an array of nucleic acid (DNA, RNA). In order to conduct such an experiment, array having high density needs to be formed on a substrate with a reasonable price.

A conventional method of fabricating a biomolecule array or polymer array may be divided into spotting, electronic addressing and photolithography. Spotting is performed by having a micro robot selectively drop a biochemical substance on a desired spot while the micro robot three-dimensionally moves. Electronic addressing is performed by fixing a biomolecule to a specific electrode of a microelectrode array after controlling the electrode voltage. Photolithography is performed by selectively exposing a desired spot on a surface to light to change the surface, which then causes a reaction at a specific location due to bonding between the surface and a biomolecule at the specific location.

In more detail, the spotting method is divided into contact printing and non-contact printing in which a solution is stamped on a paper and a solution is dropped on a paper, respectively. In contact printing, loading, printing, and washing are sequentially performed by an XYZ robot. Non-contact printing can be divided into dispensing and ink-jet printing. Dispensing involves applying a solution in a dropwise fashion, like when a micropipette is used. Ink jet printing involves applying minute pressure to a reservoir which causes a solution to be ejected.

Electronic addressing involves fixing a biomolecule to a plate using a voltage control function of the microelectrode array. Electronic addressing can be divided into a method of generating a physicochemical bond by moving a biomolecule having an electric charge to the surface of an electrode and a method of fixing a biomolecule in a thin film when the thin film is formed by electrochemical deposition.

Photolithography used in a semiconductor production process can be used to manufacture an array having high density and enables parallel synthesis. However, a number of photo masks is required, thereby increasing cost and consuming time. Therefore, a programmable mask which can control light paths through a plurality of pixels without using a photo mask is being developed and is disclosed in U.S. Pat. No. 6,271,957. The programmable mask includes a method of regulating reflection of light and a method of regulating penetration of light. For example, a micromirror array or a liquid crystal display (LCD) can be used.

The method of fabricating a biomolecule array has two problems: fabrication of a high density pattern is difficult due to diffraction of incident light, and more time is needed for forming a biomolecule such as DNA synthesis, since light intensity is decreased due to an insufficient amount of light penetration on a polarizing plate disposed at both ends of a panel in a LCD. The reasons of raising such problems are described below.

FIG. 1 is a side cross-sectional view of an apparatus for fabricating a biomolecule array including a programmable mask, in which a conventional LCD is used. Referring to FIG. 1, the apparatus includes UV polarizing plates 110 and 120, a LCD panel 130 having a color filter excluded, a DNA synthesis chamber 140, and a DNA chip board 150. Oligomers 160 and 160′ are synthesized at the bottom of the DNA chip board 150. UV light that has passed through the UV polarizing plates 110 and 120 passes through a chip having a thickness (t) and is diffracted, and thus, adjacent spots of UV light are overlapped (d). In other words, the diffraction of UV light is increased compared to the diffraction of UV in the width of a black matrix that isolates each pixel in an LCD. Therefore, when considering each pixel of a backlit LCD as an independent optical system, UV beams that have passed through a light pixel reach to the lower part of a glass substrate of a DNA chip and mix with each other. When this DNA chip is analyzed using a DNA scanner, not every DNA spot pattern is separated, and instead, it can be seen that the whole substrate of the chip is coated with oligomer. When an oligomer spot is observed on a plane surface, the overlapped oligomer 160′ can be seen. Consequently, isolation of spots is not possible and thus, the chip cannot be embodied in the form of a spot array. In order to embody a spot array of an oligomer, not all pixels can be used, and instead, unused pixels should be arranged between pixels. Therefore, since not all of the LCD pixels can be used, an array having high density cannot be embodied.

FIG. 2 is a plane view of a programmable mask and a driving circuit unit using a conventional LCD. Pattern isolation between adjacent pixels is not impossible as in FIG. 1, and pixels of the LCD should be driven in a mosaic pattern, as illustrated in FIG. 2. Each pixel in FIG. 2 is divided into domain pixels 210 (O) where an oligomer is attached and pixel areas 220 (X) where an oligomer is not attached. Since pixels X which are in complete blocking mode permanently intercepting UV light are maintained between operating pixels O, pattern mixing due to diffraction can be prevented. This also decreases the density of a DNA pattern on the oligomer chip.

Although a mosaic patterned oligomer array can be manufactured with an increase in the density of a DNA pattern, the amount of polarized light transmitted through a UV polarizing plate is small, and thus, UV exposure time which is 10 times greater is required compared to the case where photo masks for manufacturing the semiconductor are used.

### SUMMARY OF THE INVENTION

The present invention provides a programmable mask for fabricating biomolecule or polymer array having high density in very short time.

The present invention also provides an apparatus for fabricating biomolecule or polymer array having high density in very short time.

The present invention also provides a method of fabricating biomolecule or polymer array having high density in very short time.

The present invention also provides a photochemical synthesis apparatus capable of precisely defining location of regions in which photochemical synthesis occurs.

The present invention also provides a photochemical synthesis apparatus capable of easily changing location of regions in which photochemical synthesis occurs.

The present invention also provides a photochemical synthesis apparatus capable of inexpensively determining location of regions in which photochemical synthesis occurs.

According to an aspect of the present invention, there is provided programmable mask for fabricating a biomolecule array or polymer array, the mask including: a first substrate including a black matrix having openings for incident UV and first pixel electrodes; a second substrate including thin film transistors for switching pixel regions which correspond to the openings according to applied electric signals and second pixel electrodes connected to drain electrodes of the thin film transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate to polarize UV light; a second polarizing plate laminated on one side of the second substrate to polarize UV light; and a lens array layer laminated on one side of the second polarizing plate including lenses which correspond to the pixel regions.

The programmable mask may further include a driving circuit for driving the thin film transistors on the second substrate, the driving circuit being disposed outside the pixel regions.

The lens may be a hemispherical lens or a gradient index lens. The polarizing plate may have high transmittance with respect to UV light having wavelength of 320-400 nm.

The biomolecule may be nucleic acid or protein.

The nucleic acid may be selected from the group consisting of DNA, RNA, PNA, LNA, and a hybrid thereof.

The protein may be selected from the group consisting of enzyme, substrate, antigen, antibody, ligand, aptamer, and receptor.

According to another aspect of the present invention, there is provided an apparatus for fabricating a biomolecule array or polymer array including: a UV light generator including a UV light source and a lens unit through which UV light irradiated from the UV light source passes; a programmable mask for fabricating a biomolecule or polymer; wherein the programmable mask includes: a first substrate disposed so as to be spaced apart from the UV light generator, the first substrate including a black matrix having openings for incident UV light and first pixel electrodes; a second substrate including thin film transistors for switching pixel regions which correspond to the openings according to applied electric signals and second pixel electrodes connected to drain electrodes of the thin transistors; a liquid crystal layer interposed between the first substrate and the second substrate, the liquid crystal layer including liquid crystal whose arrangement can be changed according electric signals of the thin film transistors so as to selectively transmit light; a first polarizing plate laminated on one side of the first substrate to polarize UV light; a second polarizing plate laminated on one side of the second substrate to polarize UV light; and a lens array layer laminated on one side of the second polarizing plate including lenses which correspond to the pixel regions; and an array forming chamber forming a biomolecule array or polymer array, wherein the array forming chamber is laminated on the programmable mask and includes a sample plate on which the biomolecule or polymer array is formed, and a washing solution and a biomolecule or polymer flow in and out of the array forming layer.

The UV light source may be a LED two dimensional array or a laser diode two dimensional array.

The lens unit of the UV light generator may include a homogenizer lens unit to make UV light generated by the UV light source uniform, a field lens to concentrate UV light generated by the homogenizer lens unit, and a convex lens to make UV light generated by the field lens parallel.

The focal point of the lens of the programmable mask may be formed on the sample plate where a biomolecule array or polymer array is formed.

The lens of the programmable mask may be a hemispherical lens or a gradient index lens.

According to another aspect of the present invention, there is provided a programmable mask for fabricating a biomolecule array or polymer array including: a first substrate including a black matrix having openings and first pixel electrodes; a second substrate including thin film transistors for switching pixel regions which correspond to the openings according to applied electric signals and second pixel electrodes connected to drain electrodes of the thin film transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate to polarize UV light; and a second polarizing plate laminated on one side of the second substrate including a polarizing layer and a biomolecule or polymer fixed layer.

As another embodiment of the present invention, the second polarizing plate may include the polarizing layer, protecting layers laminated on both sides of the polarizing layer, and a biomolecule or polymer fixed layer having a hydrophilic surface on which a biomolecule or polymer can be fixed.

The second polarizing plate may be attached to and detached from the second substrate.

The programmable mask may further include a driving circuit for driving the thin film transistors on the second substrate, the driving circuit being disposed outside the pixel regions.

The polarizing plate may have high transmittance with respect to UV having wavelength of 320-400 nm.

The liquid crystal, as a liquid crystal in which dyes are included in a nematic liquid crystal, may be a guest-host type liquid crystal enabling to intercept or transmit light, since a vibration direction of linear polarized light and light absorption axis of the dyes are same or cross at right angles.

According to another aspect of the present invention, there is provided an apparatus for fabricating a biomolecule array or polymer array including: a UV light generator including a UV light source and a lens unit through which UV light irradiated from the UV light source passes; a programmable mask for fabricating a biomolecule or polymer; wherein the programmable mask includes: a first substrate disposed so as to be spaced apart from the UV light generator, the first substrate including a black matrix having openings and first pixel electrodes; a second substrate including thin film transistors for switching pixel regions which correspond to the openings according to applied electric signals and second pixel electrodes connected to drain electrodes of the thin transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate to polarize UV light; and a second polarizing plate laminated on one side of the second substrate to polarize UV light including a polarizing layer and a biomolecule or polymer fixed layer; and an array forming chamber forming a biomolecule array or polymer array, wherein the array forming chamber is disposed on the lower part of the second polarizing plate, and a washing solution and a biomolecule or polymer flow in and out of the array forming layer.

The UV light source may be a LED two dimensional array or a laser diode two dimensional array.

The lens unit of the UV light generator may include a homogenizer lens unit to make UV light generated from the UV light source uniform, a field lens to concentrate UV light generated from the homogenizer lens unit, and a convex lens to make UV light generated by the field lens parallel.

The second polarizing plate may include the polarizing layer, protecting layers laminated on both sides of the polarizing layer, and the biomolecule or polymer fixed layer having a hydrophilic surface on which a biomolecule or polymer can be fixed.

The second polarizing plate may be attached to and detached from the second substrate.

According to another aspect of the present invention, there is provided an apparatus for fabricating a biomolecule array or polymer array including: a UV light generator including a UV light source and a lens unit, wherein UV light irradiated from the UV light source is passed through the lens unit; a programmable mask; wherein the programmable mask includes: a first substrate disposed so as to be spaced apart from the UV light generator to have a predetermined angle with a propagation path of UV light generated by the UV light generator, the first substrate including a black matrix having openings and first pixel electrodes; a second substrate including thin film transistors for switching pixel regions which correspond to the openings according to applied electric signals, second pixel electrodes connected to drain electrodes of the thin transistors, and reflection layers for reflecting incident UV; a liquid crystal layer interposed between the first substrate and the second substrate, the liquid crystal layer including liquid crystal whose arrangement can be changed according to electric signals of the thin film transistors so as to selectively transmit light; and an array forming chamber forming a biomolecule array or polymer array, wherein the array forming chamber is spaced apart from the programmable mask to have a right angle to the UV light path reflected from the programmable mask and includes a sample plate on which the biomolecule or polymer array is formed, and a washing solution and a biomolecule or polymer flow in and out of the array forming layer.

The UV light source may be a LED two dimensional array or a laser diode two dimensional array

The lens unit of the UV light generator may include a homogenizer lens unit to make UV light generated from the UV light source uniform, a field lens to concentrate UV light generated from the homogenizer lens unit, and a convex lens to make UV light generated from the field lens parallel.

According to another aspect of the present invention, there is provided a method of fabricating a biomolecule array or polymer array using a programmable mask for fabricating a biomolecule array or polymer array, wherein the programmable mask includes: a first substrate including a black matrix having openings and first pixel electrodes; a second substrate including thin film transistors for switching pixel regions which correspond to the openings according to applied electric signals and second pixel electrodes connected to drain electrodes of the thin film transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate; a second polarizing plate laminated on one side of the second substrate; and a lens array layer laminated on one side of the second polarizing plate including lenses which correspond to the pixel regions, the method including: irradiating UV light to selective regions of a sample plate on which molecules having a protecting group are fixed through the programmable mask; and flowing a solution containing biomolecule or polymer monomer, required to fix to the molecule.

According to another aspect of the present invention, there is provided a method of fabricating a biomolecule array or polymer array using a programmable mask for fabricating a biomolecule array or polymer array, wherein the programmable mask includes: a first substrate including a black matrix having openings and first pixel electrodes; a second substrate including thin film transistors for switching pixel regions which correspond to the openings according to applied electric signals and second pixel electrodes connected to drain electrodes of the thin film transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate; and a second polarizing plate laminated on one side of the second substrate including a polarizing layer and a biomolecule or polymer fixed layer, the method including: irradiating UV light to selective regions of a sample plate on which molecules having a protecting group are fixed through the programmable mask; and flowing a solution containing biomolecule or polymer monomer, required to fix to the molecule.

According to another aspect of the present invention, there is provided a photochemical synthesis apparatus for selectively forming source materials in a predetermined region on a substrate, the apparatus including: a reaction chamber onto which the substrate is loaded and into which reaction molecules forming the source materials are supplied; a light source providing reaction light, the light source being disposed above the substrate; and a transmission region controller variably controlling regions through which the reaction light can be transmitted to the substrate, the transmission region controller being disposed between the light source and the substrate, wherein the reaction light comprises laser light having a high degree of coherence.

The reaction light has a wavelength which induces the source materials to be attached to the substrate. In addition, the source materials may include at least one of DNA monomers for analyzing gene expression and single nucleotide polymorphism, an activator solution, amino acids and proteins for protein synthesis, monomers and polymers for polymer synthesis, and a cleaning solution. Here the source materials may include a protecting molecule capable of being photo-deprotected by the reaction light.

The transmission region controller may include transmission regions that are two dimensionally arranged, the transmittance of the transmission regions being controlled in response to an electrical signal. For example, the transmission region controller may include a liquid crystal display (LCD) using a voltage-transmittance characteristic of a liquid crystal layer, the LCD including: pixels that are two-dimensionally arranged; a pixel controller generating an operating voltage for controlling transmittance of the pixels; and wirings connecting to the pixels and transmitting the operating voltage to the pixels.

The source materials may include at least one of a plurality of DNA monomers, the reaction light comprises laser light having a wavelength of a UV band and a high degree of coherence. Here, the operating voltage may be selected to prevent the LCD being damaged by the laser light having a wavelength of a UV band.

The transmission region controller may be configured to have a narrow viewing angle (for example, approximately 0-45 degrees) and may be approximately 0-10 degrees.

The photochemical synthesis apparatus may further include a reaction light controller for controlling at least one of progressing direction, intensity, and incident angle to the substrate of the reaction light, the reaction light controller being disposed between the light source and the substrate. Here, the reaction light controller may be configured for the reaction light to form parallel light which is substantially vertically incident to the upper surface of the substrate.

According to another aspect of the present invention, there is provided a photochemical synthesis apparatus for selectively forming source materials in a predetermined region on a substrate, the apparatus including: at least one light source generating reaction light; a plurality of reaction chambers onto which a plurality of substrates are respectively loaded; a reaction light controller guiding the reaction light to the substrates; and a transmission region controller variably controlling regions through which the reaction light can be transmitted to the substrates, the transmission region controller being disposed between the reaction light controller and the substrates, wherein the reaction light controller comprises a plurality of optical splitters splitting the reaction light so as to be provided to the plurality of substrates.

The reaction light controller may include a plurality of half mirrors which split the reaction light into transmission light and reflection light, each progressing in a direction parallel to and perpendicular to the incident light, the half mirrors being configured for the transmission light or reflection light transmitted by the light source or another of the half mirrors to be transmitted to the substrate or another of the half mirrors.

The reaction light controller may be configured for intensity of the reaction light incident to the substrates to be substantially the same. For example, the optical splitters may be disposed to correspond to the substrates, respectively, and the reaction light controller further comprises one or more attenuators disposed between at least one of the substrates and the corresponding optical splitters. Here, the attenuators disposed between the substrate and corresponding optical splitter may be configured to have reduced attenuation if the number of optical splitters arranged on the progressing path of the reaction light incident to the substrates is increased.

The reaction light controller may be configured to form a path of a first reaction light incident to the substrates in a first order and a path of a second light reaction incident to the substrates in a second order opposite to the first order, between the reaction light and the substrates.

The reaction light may include laser light having a wavelength which induces the source materials to be attached to the substrates, and a high degree of coherence. In addition, the source materials may include at least one of DNA monomers for analyzing gene expression and single nucleotide polymorphism, an activator solution, amino acids and proteins for protein synthesis, monomers and polymers for polymer synthesis, and a cleaning solution. The source materials may include a protecting molecule capable of being photo-deprotected by the reaction light.

The transmission region controller may include transmission regions that are two dimensionally arranged, the transmittance of the transmission regions being controlled in response to an electrical signal. For example, the transmission region controller may include a liquid crystal display (LCD) using a voltage-transmittance characteristic of a liquid crystal layer, the LCD comprising: pixels that are two-dimensionally arranged; and a pixel controller generating an operating voltage for controlling transmittance of the pixels, the pixel controller controlling transmittance of the pixels according to location of the pixels and the types of the source materials applied to the reaction chambers, in order for the source materials to be formed as different stacking structures on the substrates, respectively.

The source materials may include at least one of a plurality of DNA monomers, the reaction light comprises laser light having a wavelength of a UV band and a high degree of coherence, and the operating voltage is selected to prevent the LCD being damaged by the laser light having a wavelength of a UV band. For example, the operating voltage may be selected for the liquid crystal layer to be operated in a complete transmission mode and a complete blocking mode.

Meanwhile, the reaction light controller may be configured for the reaction light to form parallel light which is substantially vertically incident to the upper surface of the substrate.

### BRIEF DESCRIPTION OF THE DRAWINGS

The above and other features and advantages of the present invention will become more apparent by describing in detail exemplary embodiments thereof with reference to the attached drawings in which:

FIG. 1 is a side cross-sectional view of an apparatus for fabricating a biomolecule array or polymer array including a programmable mask, in which a conventional LCD is used;

FIG. 2 is a plane view of a programmable mask and a driving circuit unit using a conventional LCD;

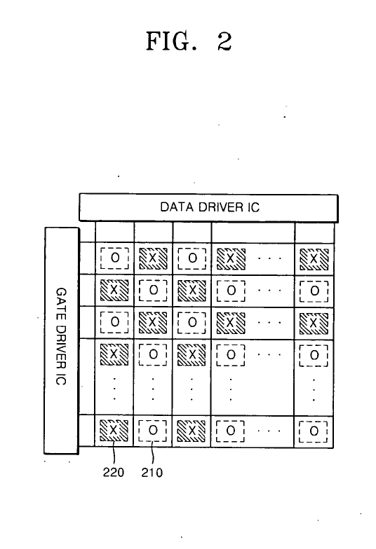

FIG. 3A is a graph showing transmittance-voltage with respect to UV exposure time of a LCD;

FIG. 3B is a graph showing contrast with respect to UV exposure time of a LCD;

FIG. 4 is a side cross-sectional view of an apparatus for fabricating a biomolecule array or polymer array including a programmable mask in which a LCD according to an embodiment of the present invention is used;

FIG. 5 is a side cross-sectional view of an apparatus for fabricating a biomolecule array or polymer array including a programmable mask in which a LCD according to another embodiment of the present invention is used;

FIG. 6 is a plane view of a programmable mask and a driving circuit unit using the LCD according to an embodiment of the present invention;

FIG. 7 is a side cross-sectional view of an apparatus for fabricating a biomolecule array or polymer array including a programmable mask in which a LCD according to another embodiment of the present invention is used;

FIG. 8 is a perspective view of a second polarizing plate used in FIG. 7;

FIG. 9 is a side cross-sectional view of a general reflective LCD;

FIG. 10 is a side cross-sectional view of an apparatus for fabricating a biomolecule array or polymer array including a programmable mask in which a reflective LCD according to another embodiment of the present invention is used; and

FIG. 11 is a schematic view illustrating a UV light generator according to an embodiment of the present invention.

FIG. 12 is a diagram schematically illustrating a photochemical synthesis apparatus according to an embodiment of the present invention;

FIG. 13 is a cross-sectional view of a photochemical synthesis apparatus using a liquid crystal display (LCD) as a transmission region controller, according to an embodiment of the present invention;

FIG. 14 is a diagram of a photochemical synthesis apparatus according to another embodiment of the present invention;

FIG. 15 is a diagram for explaining a reaction light controller according to an embodiment of the present invention;

FIGS. 16A through 16D are diagrams of photochemical synthesis apparatuses according to other embodiments of the present invention; and

FIGS. 17A through 17C are photographic images of gene diagnostic chips manufactured using a photochemical synthesis apparatus according to the present invention.

### DETAILED DESCRIPTION OF THE INVENTION

Hereinafter, the present invention will be described more fully with reference to the accompanying drawings, in which exemplary embodiments of the invention are shown.

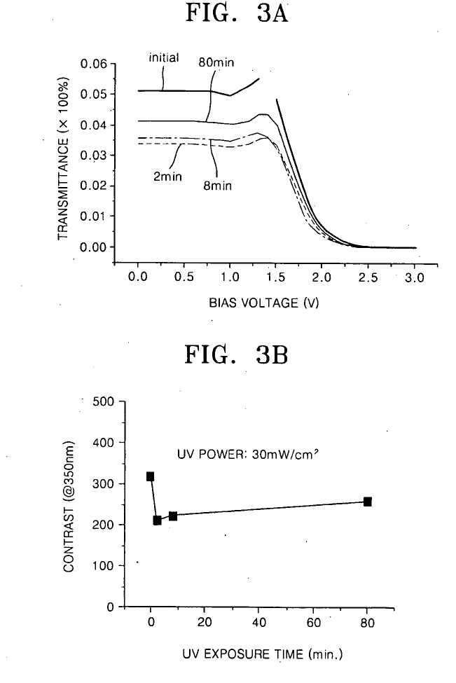

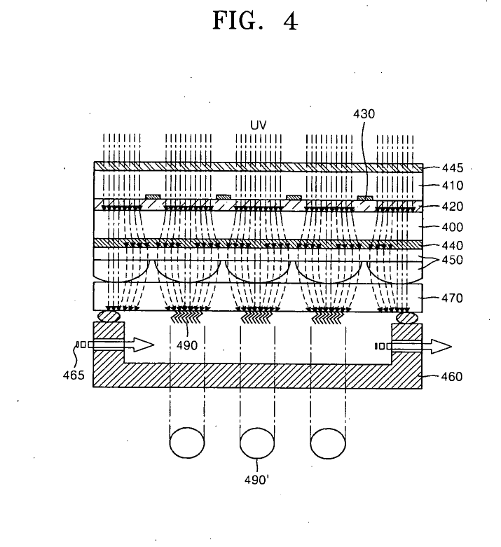

FIG. 3A is a graph showing transmittance with respect to voltage for different UV exposure times of a LCD and FIG. 3B is a graph showing contrast with respect to UV exposure time of a LCD.

In order to analyze the stability of liquid crystal and an alignment film of a LCD with respect to UV, a UV polarizing plate of the LCD is separated and removed, and UV light having wavelength of 350 nm and an intensity of 160 mW/cm² used in a DNA synthesis is irradiated onto the LCD. Then, the polarizing plate for UV is attached back to the LCD and the transmittance with respect to voltage and contrast change with respect to UV exposure time are analyzed using a UV-visible spectrophotometer.

Referring to FIGS. 3A and 3B, a sudden decline in contrast occurs in an initial stage of UV irradiation, however, the contrast is stable thereafter. Thus, in complete blocking mode, as UV exposure time increases, UV leakage does not increase and yield of an oligomer chip is not affected. In addition, since the LCD is damaged by UV light, gray scale is destroyed and thus, cannot be used in displaying. However, the property of blocking UV light at a LCD complete blocking mode of a voltage of 2.5 V or above is not changed. On the other hand, a change in transmittance is observed at a complete transmission mode of a voltage of 1.5 V or less, however, can be used in the present invention. In the LCD of the present invention, only a complete transmission mode and a complete blocking mode are important and the voltage range in which transmittance with respect to voltage is suddenly changed, that is, the voltage range of 1.5-2.5 V, is not used in the present invention. In particular, even if there is excessive UV irradiation, the amount of UV leakage is nearly changed in the complete blocking mode. As shown in the graph of FIG. 3B, even if the LCD is exposed to UV light having an intensity of 160 mW/cm² for 80 minutes, contrast is not decreased as time elapses.

In synthesis of DNA oligomer, UV light is transmitted to a LCD in a complete transmission mode or completely blocked in a complete blocking mode for UV photo deprotection of a deprotecting group such as NPPOC[2-(2-nitrophenyle)-ethoxycarbony] and molecule, MeNPOC[((alpha-methyl-2-nitropipheronyl)-oxy)carbonyl], after optical pumping used in synthesis of photolithgraphic DNA which is attached to a side chain 5′ of a DNA monomer.

When LCDs are used for display purposes, color is embodied by slightly changing the amount of light to specific pixels. However, when a LCD is used as a mask, UV light is completely transmitted to the LCD or completely intercepted for photo deprotection of UV.

In a DNA chip, an oligonucleotide is generally formed by coupling 25 DNA monomers together. Spots disposed on a DNA chip glass substrate, which correspond to openings in the liquid crystal, couple with DNA molecules according to predetermined DNA sequences. The spots disposed on the DNA chip, which correspond to the respective pixels, have different DNA sequences. Nucleotide formed of DNA includes adenine (A), thymin (T), cytosine (C), and guanine (G). First, as an example of synthesis, adenine (A) is formed on a region of the DNA chip which corresponds to a specific pixel. Then, when thymin (T) is synthesized in a region corresponding to another pixel, the region where adenine (A) is synthesized may be prevented from being synthesized with thymin (T). DNA bases which are attached to the DNA chip have a protecting group attached thereto, so if other bases approach the DNA bases, coupling does not occur before UV is irradiated.

Adenine (A) of the specific pixel described above also has a protecting group attached thereto, so if other bases approach the DNA bases, coupling does not occur before UV is irradiated. However, in order to synthesize thymin (T) with another pixel, during UV light irradiation, no UV light should reach the protecting group in adenine (A) attached to the specific pixel. That is, a specific pixel of the LCD according to the present invention should minimize UV leakage in a complete blocking mode. Spots on the DNA chip, which correspond to the respective pixels, have specific regions, wherein oligonucleotides exist in the region.

If some UV light is leaked from a specific pixel of the liquid crystal, thymin (T) is coupled to a specific adenine (A) on a region of the DNA chip which corresponds to the specific pixel, while some of the oligonucleotides become oligonucleotides having different sequences, and thus, the yield of the synthesis is decreased. Since incident UV light is in the form of a UV beam that is bigger than the area of the LCD, a liquid crystal cell is needed to completely block UV light. When UV is irradiated on an alignment layer and on liquid crystal, and thus, a gray scale is destroyed, damage due to UV occurs when the LCD is used as a display such as a TV or monitor. However, as illustrated in FIG. 3, the LCD can be used as a UV light valve which requires complete transmission mode and complete blocking mode only.

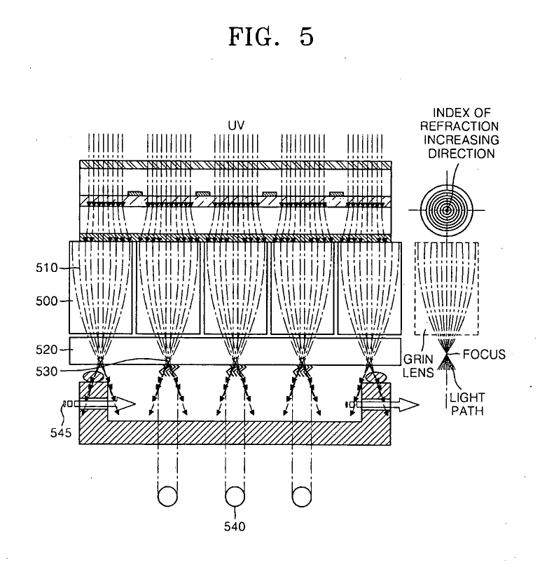

FIG. 4 is a side cross-sectional view of an apparatus for fabricating a biomolecule array or polymer array including a programmable mask, in which a LCD according to an embodiment of the present invention is used.

Referring to FIG. 4, the apparatus includes a UV light generator (not illustrated), a programmable mask 410 to 450, a sample plate 470, and an array forming chamber 460.

Here, the programmable mask is an apparatus to control transmission, reflection, and interception of incident light in a pixel unit.

The programmable mask includes a first substrate 410 including a black matrix 430 having openings and first pixel electrodes (not illustrated); a second substrate 400 including thin film transistors (not illustrated) for switching pixel regions which correspond to the openings in response to applied electric signals and second pixel electrodes (not illustrated) connected to drain electrodes of the thin film transistors; a liquid crystal layer 420 interposed between the first substrate 410 and the second substrate 400 and including liquid crystal to selectively transmit light after arrangement of the liquid crystal layer 420 is changed according to electric signals of the thin film transistors; a first polarizing plate 445 laminated on one side of the first substrate 410; a second polarizing plate 440 laminated on one side of the second substrate 400; and a hemispherical lens array layer 450 laminated on one side of the second polarizing plate 440 and including hemispherical lenses which correspond to the pixel regions.

The programmable mask may further include a driving circuit for driving the thin film transistors on the second substrate 440 in the outer pixel region, but a driving circuit is not illustrated.

In the present invention, the polarizing substrates 440 and 445 may have high transmittance with respect to UV having a wavelength of 320-400 nm. The liquid crystal, which is a liquid crystal in which dyes are included in a nematic liquid crystal, is a guest-host type liquid crystal enabling light to be to intercepted or transmitted, since a vibration direction of linear polarized light and the light absorption axis of the dyes are the same or cross at right angles.

The biomolecule of the present invention may be a nucleic acid or a protein. The nucleic acid can be selected from the group consisting of DNA, RNA, PNA, LNA, and a hybrid thereof. The protein can be selected from the group consisting of enzyme, substrate, antigens, antibodies, ligands, aptamers, and receptors.

Biomolecules or polymers, for example, a DNA monomer having a side chain molecule that can be desorbed by UV light, such as 5′-NPPOC (or MeNPOC)-dT, 5′-NPPOC (or MeNPOC)-dA, 5′-NPPOC (or MeNPOC)-dG, and 5′-NPPOC (or MeNPOC)-dC, and a washing solution 465 can flow in and out of the array forming chamber 460.

The hemispherical lens array layer 450 can be used to focus the UV energy so as to make it high enough for desorption of molecules such as NPPOC and MeNPOC, wherein the NPPOC and MeNPOC can be attached to a side chain of a DNA nucleotide (dA,dT,dG,dC) and can be desorbed by UV light.

The programmable mask includes the hemispherical lens array layer 450 on the side where two glass substrates of a backlit LCD or the quartz substrates 400 and 410 through which UV is transmitted to be out and thus, the UV out through the each pixel is collected. Therefore, UV irradiation time is reduced and mixing with other adjacent patterns can be prevented.

The hemispherical lens can be formed using a hemispherical mold when a glass substrate is manufactured on the glass substrate of the backlit LCD. Instead of directly forming the hemispherical lens on the glass substrate of the backlit LCD, the hemispherical lens array may be formed on another glass substrate which is then attached to the glass substrate of the backlit LCD so that the hemispheres correspond one-to-one with the LCD pixels. The hemispherical lens optically collects incident light and improves the intensity of UV. In addition, the focal point of the hemispherical lens may be formed on the lower part of the DNA oligomer chip substrate disposed on the DNA oligomer synthesis chamber.

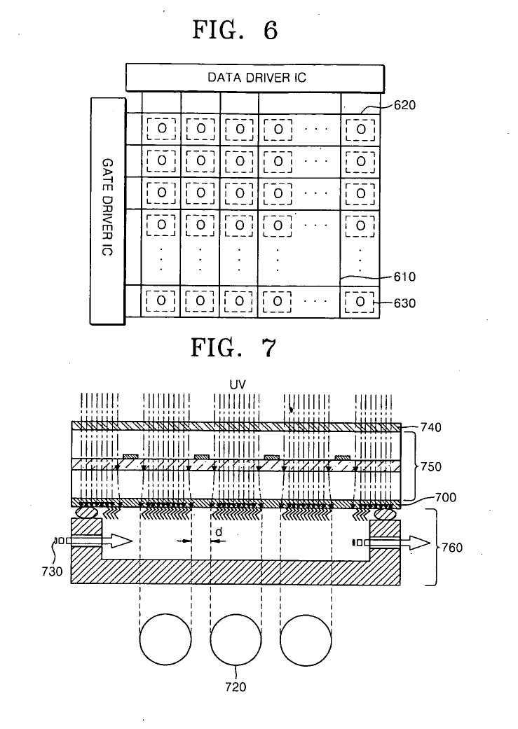

FIG. 5 is a side cross-sectional view of an apparatus for fabricating biomolecule or a polymer, including a programmable mask in which a LCD according to another embodiment of the present invention is used.

Unlike in FIG. 4 in which the hemispherical lens array is used, a gradient index lens 500 is used in FIG. 5. Accordingly, UV irradiation time is significantly reduced, and thus, the time required for synthesis of an oligomer can be reduced. The gradient index lens 500 has a flat optical surface instead of a bent surface, and thus, assembling work to form array is easy. Also, the gradient index lens 500 is manufactured so that the index of refraction gradually increases toward the center of the lens and thus, light continuously bends until it finally focuses on one spot within the lens, thereby increasing the intensity of light due to light collecting.

The focal distance 530 of the gradient index lens may be chosen so that the focal point is formed around a lower part of a DNA oligomer chip substrate 520 disposed on a DNA synthesis chamber. Accordingly, the intensity of UV light is expected to increase by more than 5 times around the focal point 530 of the gradient index lens due to the collecting of UV light and thus, synthesis time can be reduced to ⅕ or less of the normal time. Also, a spot surface 540 of oligomer pattern can be significantly reduced and density of oligomer pattern can be improved.

A method of forming gradient index lens (Grin lens) array includes making a hole in an opaque substrate such as a silicon substrate so as to correspond one-to-one with the LCD pixels, inserting grin lenses into each hole disposed on the substrate, and attaching the substrate to a lower part of a glass substrate of the LCD. The grin lens of the present invention has an object of improving intensity of UV by optically collecting incident light. Therefore, the focal point of the grin lens may be selected to be formed on the lower surface of the DNA oligomer chip substrate disposed on the DNA oligomer synthesis chamber.

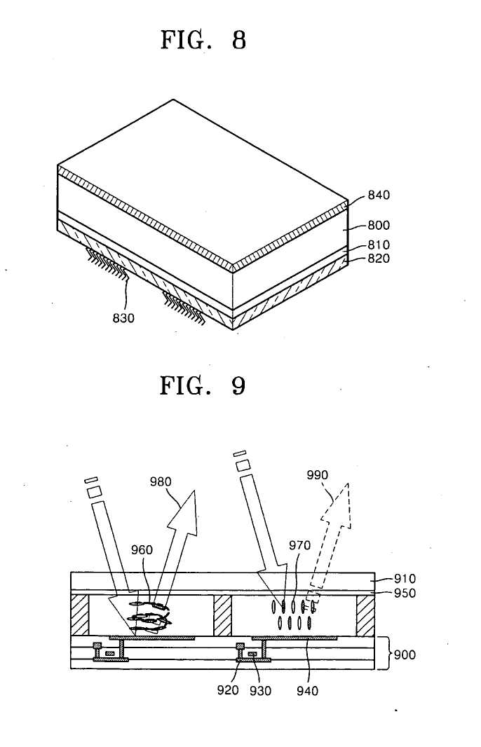

FIG. 6 is a plane view of a programmable mask and a driving circuit unit using the LCD according to an embodiment of the present invention.

Referring to FIG. 6, the programmable mask and the driving circuit unit using the LCD according to an embodiment of the present invention includes a data signal line 610, a gate signal line 620, and a pixel 630 defined by the data signal line 610 and the gate signal line 620. As described above, the hemispherical lens array and the gradient index lens array are attached to the lower part of the glass substrate of the backlit LCD so as to correspond one-to-one with the LCD pixels and thus, a UV light collecting effect and pattern isolation effect between adjacent pixels can be achieved. Therefore, all pixels of the LCD can be used to form an oligomer pattern array, and thus, the density of the oligomer pattern of the present invention is twice that of the conventional art. The mark O in all pixels in FIG. 6 indicates that all pixels can be used.

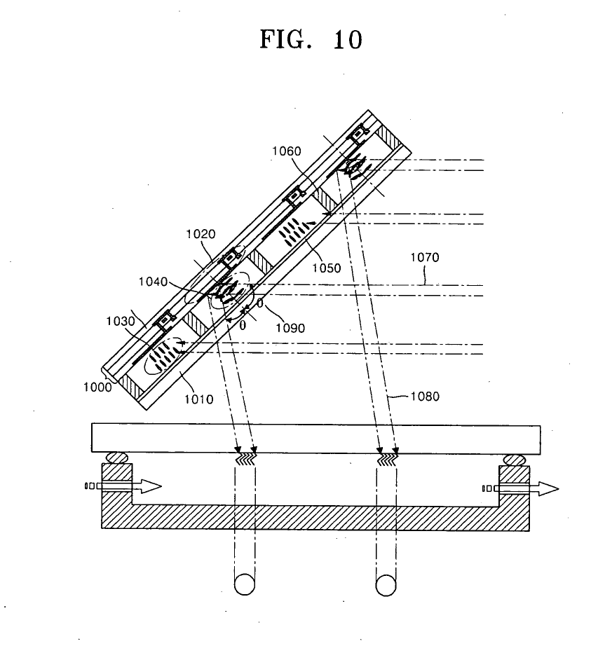

FIG. 7 is a side cross-sectional view of an apparatus for fabricating biomolecule or a polymer including a programmable mask in which a LCD according to another embodiment of the present invention is used.

Referring to FIG. 7, the apparatus includes a LCD 750 including two substrates and a liquid crystal layer, and a first polarizing plate 740 and a second polarizing plate 700 disposed on the top and bottom surfaces of the LCD 750, respectively.

The second polarizing plate 700 disposed on the lower substrate of the LCD is formed to reduce optical diffraction by removing the distance between chip glass substrates in the oligomer synthesis chamber. The substrates are glass or quartz substrates formed of LCDs. The second polarizing plate 700 attached to the outer surface of the lower substrate is used not only for optical purposes to get polarized light but also as a DNA oligomer chip substrate.

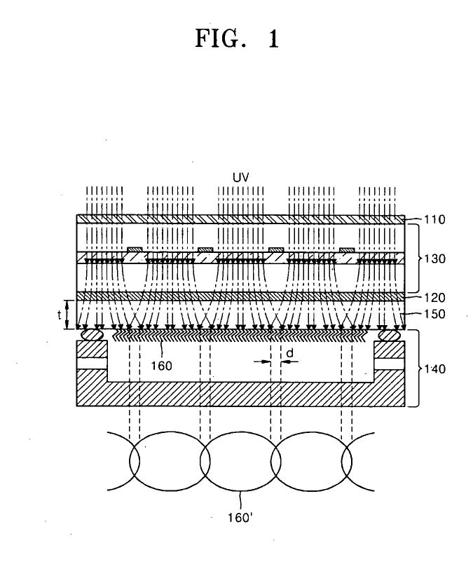

In general, the glass substrate on the DNA oligomer synthesis chamber, that is, the DNA oligomer chip substrate, is formed of a glass substrate having a thickness of 600-1000 um. UV light that passes through a lower polarizing plate of a backlit LCD passes through the glass substrate and a predetermined amount of UV light is diffracted. Disadvantages regarding this are fully described in the description of FIG. 1. If the polarizing plate disposed on the lower part of the LCD is used as a substrate of an oligomer chip, the lower surface of the polarizing plate becomes a lid of the synthesis chamber and contacts solutions 730 that are essential for synthesis, such as a DNA monomer, a washing solution, and acetonitrile having a side chain, wherein the side chain is a molecule that is optically pumped through light desorption using UV light and may be, for example, 5′-NPPOC (or MeNPOC)-dT, 5′-NPPOC (or MeNPOC)-dA, 5′-NPPOC (or MeNPOC)-dG, and 5′-NPPOC (or MeNPOC)-dC, which are included in the synthesis chamber. The lower surface of the lower polarizing plate 700 is used as a substrate where DNA is synthesized by UV. As a result of the synthesis, a DNA spot is isolated from an adjacent spot (d), since the diffraction which occurs on the conventional DNA chip glass substrate is removed. In FIG. 7, a reference numeral 720 is a plane view of a synthesis spot.

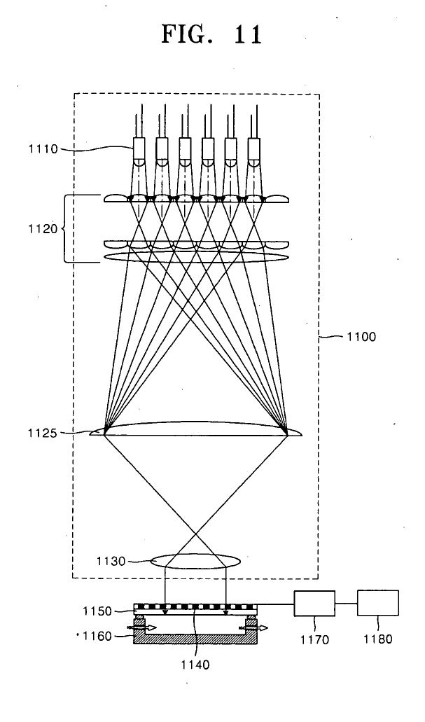

FIG. 8 is a perspective view of an embodiment of the second polarizing plate 700 shown in FIG. 7. Referring to FIG. 8, the second polarizing plate 700 includes a polarizing layer 800 formed of polarizing materials, protecting layers 810 and 840 laminated on both sides of the polarizing layer 800, and a biomolecule or polymer fixed layer 820 having a hydrophilic surface on which a biomolecule or polymer 830 can be fixed.

The biomolecule or polymer fixed layer 820 may be a thin film to which a hydroxyl group (—OH) or an amine group (NH₃) can be attached, for example, a silicon oxide layer. When the first DNA monomer flows into the synthesis chamber in a synthesis process, 3′ part of a monomer is combined with the hydroxyl group (—OH) or the amine group (NH₃) attached to the fixed layer 820. Then, as the synthesis process progresses, a DNA oligomer 830 is formed.

The polarizing substrate on which the DNA oligomer is synthesized can be separated from the lower glass substrate of the backlit LCD to perform DNA hybridization after the DNA oligomer is synthesized.

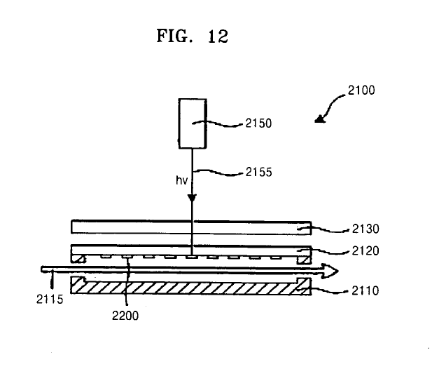

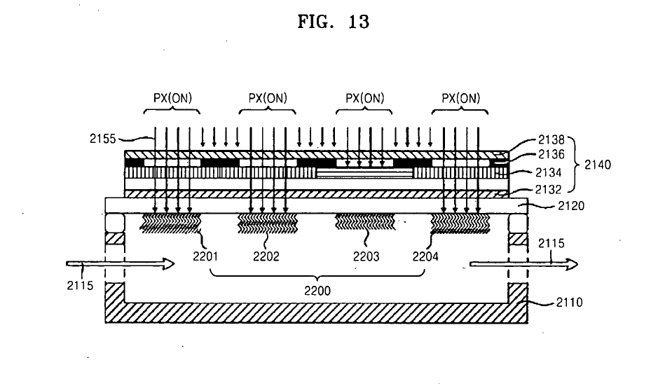

FIG. 9 is a side cross-sectional view of a general reflective LCD and FIG. 10 is a side cross-sectional view of an apparatus for fabricating a biomolecule array or polymer array including a programmable mask in which a reflective LCD according to another embodiment of the present invention is used.

Referring to FIG. 9, the general reflective LCD includes a first substrate 910 including a black matrix (not illustrated) having openings and first pixel electrodes 950, a second substrate 900 including thin film transistors 920 for switching pixel regions which correspond to the openings according to applied electric signals, second pixel electrodes 940 connected to drain electrodes 930 of the thin transistors, and reflection layers 940 for reflecting incident UV, and liquid crystal layers 960 and 970 interposed between the first substrate 910 and the second substrate 900 including liquid crystal to selectively transmit light after arrangement of the liquid crystal layer is changed according to electric signals of the thin film transistors 920.

The liquid crystal layer 960 is connected to a voltage, and thus, incident light is transmitted and reflected through the liquid crystal layer 960 and reflected light 980 is emitted. However, voltage is removed in another liquid crystal layer 970 and incident light is intercepted, and thus, reflected light cannot be emitted (990).

Referring to FIG. 10, the apparatus for fabricating a biomolecule array including a programmable mask in which a reflective LCD according to another embodiment of the present invention is used uses the reflective LCD of FIG. 9 as the programmable mask for fabricating a biomolecule array.

UV incident light 1070 is incident to a normal of an upper glass substrate 1010 of the reflective LCD panel with a predetermined incident angle 1090. A reflective angle is the same as the incident angle and light is reflected on the opposite side of the normal at the reflective angle. Reflected light 1080 synthesizes an oligomer nucleotide on the lower part of the DNA chip glass substrate of a DNA synthesis chamber.

The propagation direction of the reflected light 1080 reflected from the liquid crystal using the reflective LCD is set to cross at right angles to the upper DNA chip glass substrate of the DNA synthesis chamber.

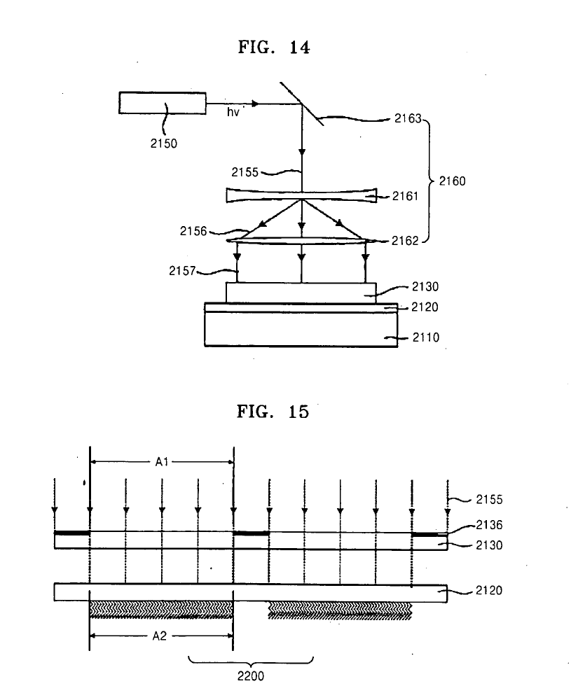

FIG. 11 is a schematic view illustrating a UV light generator according to an embodiment of the present invention.

In general, conventional UV irradiators formed of a mercury lamp and optical lens for irradiating UV incident light to a LCD panel are large and have a volume of 1 to 3 meters. Therefore, a UV light generator having a relatively small size to get uniform UV beams is proposed in the present invention.

Referring to FIG. 11, the UV light generator 1100 of the present invention includes a UV light source 1110 and a lens unit 1120 or 1130 through which UV light irradiated from the UV light source 1110 passes.

The UV light source 1110 may be a LED two dimensional array or a laser diode two dimensional array.

The lens unit of the UV light generator 1110 may include a homogenizer lens unit 1120 to make UV generated from the UV light source 1110 uniform, a field lens 1125 to concentrate UV generated from the homogenizer lens unit 1120, and a convex lens 1130 to make UV generated from the field lens 1125 parallel.

As illustrated in the drawings described above, the present invention also provides a method of fabricating a biomolecule array or polymer array using the programmable mask or the apparatus for fabricating an array. The method includes irradiating UV light to selected regions of a sample plate on which molecules having a protecting group are fixed through the programmable mask and flowing a solution containing a biomolecule or a polymer monomer, required to fix to the molecule.

As described above, a biomolecule array or polymer array on which biomolecules or polymers are fixed with higher density than that of a conventional biomolecule array or polymer array can be achieved according to the present invention. Also, the time required for manufacturing the biomolecule or polymer array can be reduced.

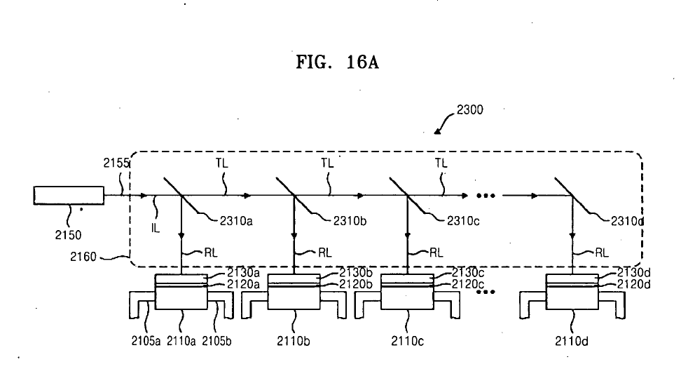

FIG. 12 is a diagram schematically illustrating a photochemical synthesis apparatus 2100 according to an embodiment of the present invention.

Referring to FIG. 12, the photochemical synthesis apparatus 2100 according to the current embodiment of the present invention includes a light source 2150, a reaction chamber 2110, a substrate 2120 disposed between the light source 2150 and the reaction chamber 2110, and a transmission region controller 2130 disposed between the substrate 2120 and the light source 2150.

The substrate 2120 is loaded onto the reaction chamber 2110 and source materials 2115 for photochemical synthesis are supplied to the reaction chamber 2110. In order to supply the source materials 2115 to the reaction chamber 2110, pipes (not shown) for inflow and outflow of the source materials 2115 are connected to the reaction chamber 2110 and the pipes may be connected to a container (not shown) storing the source materials 2115 and a collecting container to which the source materials 2115 are delivered, or other reaction chamber.

The photochemical synthesis apparatus 2100 according to the current embodiment of the present invention may be used to manufacture chips for analyzing gene expression or single nucleotide polymorphism. In this case, the source materials 2115 may include at least one of DNA monomers, an activator solution, and a cleaning solution. Here, for selective synthesis by light, NPPOC[2-(2-nitrophenyle)-ethoxycarbony], MeN POC[((alpha-methyl-2-nitropipheronyl)-oxy)carbonyl] protecting molecule having a photo-deprotection characteristic may be attached to side branches of DNA monomers. When the protecting molecule is not attached to DNA monomers by light generated by the light source 2150, the corresponding DNA monomer is not coupled with other DNA monomers.

In addition, the photochemical synthesis apparatus 2100 according to the current embodiment of the present invention may be used to selectively synthesize proteins or polymers. In this case, the source materials 2115 may include amino acids and proteins for protein synthesis or monomers and polymers for polymer synthesis. Meanwhile, the source materials 2115 are illustrated for schematically explaining the technical field to which the present invention can be applied. However, the technical idea of the present invention is not limited to the above-described source materials and can be applied to various other technical fields based on photochemical synthesis.

The light source 2150 generates light having a predetermined wavelength and the light (hereinafter, referred to as a reaction light 2155) provides reaction energy for a coupling reaction in which the source materials 2115 are attached to the lower surface of the substrate 2120. Accordingly, the light source 2150 is formed to generate the reaction light 2155 having a frequency that is greater than a predetermined critical frequency or intensity that is greater than a predetermined critical intensity. In addition to this, in order to precisely define regions where the coupling reaction of the source materials 2115 occurs, the light source 2150 is formed for the reaction light 2155 to have a high degree of coherence. For example, the reaction light 2155 may be laser light having a wavelength of a UV band (more specifically, a wavelength of 310 nm to 370 nm). However, the wavelength and intensity of the reaction light 2155 may be determined according to the types of the source materials 2115 and are not limited thereto. Meanwhile, the photochemical synthesis apparatus 2100 according to the current embodiment of the present invention is configured for the reaction light 2155 to cover an area the same as or greater than that of the transmission region controller 2130 and to be incident to the transmission region controller 2130.

The transmission region controller 2130 determines the region through which the reaction light 2155 can be transmitted. That is, the extent of the region on the substrate 2120 to which the reaction light 2155 can reach is determined by the transmission region controller 2130. As described above, in photochemical synthesis, the coupling reaction between the source materials 2115 and the substrate 2120 occurs according to whether the reaction light 2155 is incident and thus the transmission region controller 2130 which determines the transmission region of the reaction light 2155 determines location of the region where photochemical synthesis occurs. In other words, the planar location of a material layer 2200 grown through photochemical synthesis is determined by the transmission region controller 2130 and a vertical configuration thereof is determined by changing the supplied source materials 2115.

Meanwhile, according to the current embodiment of the present invention, the transmission region controller 2130 is configured for the transmission region to be changed according to needs of users. For example, the transmission region controller 2130 may include transmission regions that are two-dimensionally arranged, wherein the transmittance of each transmission region is electrically controlled. According to the current embodiment, the transmission region controller 2130 may be a liquid crystal display (LCD) having a liquid crystal layer in which transmittance thereof is controlled by a voltage applied thereto.

A conventional photo-mask also includes patterned chrome patterns so as to determine a region through which the reaction light 2155 is transmitted. However, the transmission region cannot be freely changed by the photo-mask. Thus, a conventional photo-mask is required to be changed according to the types of the supplied source materials, in order to form synthesized materials layers each having a different molecular structure. Unlike this, the transmission region controller 2130 according to the current embodiment of the present invention can variably control the transmission regions according to needs of users, as described above, so that the regions where photochemical synthesis occurs can be controlled without changing the photo-mask.

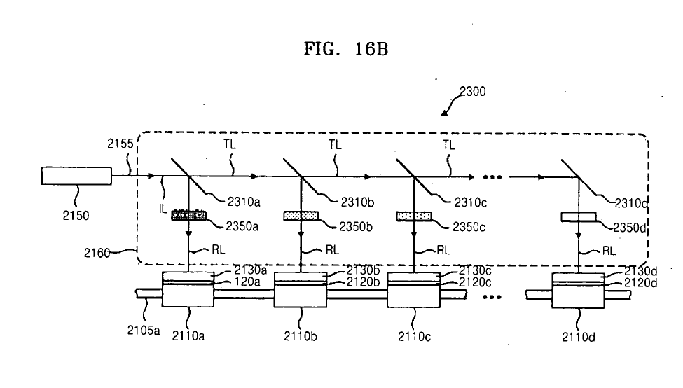

FIG. 13 is a cross-sectional view of a photochemical synthesis apparatus using a LCD 140 as a transmission region controller, according to an embodiment of the present invention. For a concise description, the photochemical synthesis apparatus according to the current embodiment is used to manufacture chips for analyzing gene expression or single nucleotide polymorphism. However, as described above with reference to FIG. 12, the photochemical synthesis apparatus according to the present invention is not limited thereto and can be used in various technical areas that are based on a photochemical synthesis mechanism.

Referring to FIG. 13, the LCD 2140 of the photochemical synthesis apparatus according to the current embodiment corresponds to the transmission region controller 2130 of the photochemical synthesis apparatus of FIG. 12. The LCD 2140 includes a pixel controller (not shown) which generates pixels PX that are two-dimensionally arranged, wherein transmittance of the pixels PX is controlled in response to electrical signals, and an operating voltage for controlling transmittance of the pixels PX.

Protecting molecules of a DNA monomer are attached to regions 201, 202, and 204 disposed under pixels PX (ON) having high transmittance and are not attached to a region 203 disposed under pixels PX (OFF) through which transmission of a reaction light 2155 is blocked. Accordingly, DNA monomers included in source materials 2115, as illustrated, can be selectively grown only in the regions 201, 202, and 204 disposed under the pixels PX (ON) having high transmittance.

The LCD 140 includes polarizers 132 and 138 and a liquid crystal layer 134. The LCD 140 may also include operating devices (not shown) arranged in each pixel PX for controlling transmittance of the liquid crystal layer 134, and wirings (not shown) connecting the operating devices. In addition to this, alignment layers (not shown) may be further disposed on the upper part and lower part of the liquid crystal layer 134 for controlling arrangement of liquid crystal, and shielding patterns 136 defining the pixels PX may be further disposed on the upper part or lower part of the liquid crystal layer 134.

According to the current embodiment of the present invention, the LCD 140 is configured to prevent the liquid crystal layer 134 and the polarizers 132 and 138 from being thermalized by the reaction light 2155. For example, the LCD 140 may further include a temperature controller (not shown) for reducing thermal stress occurring due to the reaction light 2155. The temperature controller may be a cooling device using the Peltier effect.

According to another embodiment of the present invention, the pixel controller may be configured to generate an operating voltage capable of preventing the liquid crystal layer 134 from being thermalized by the reaction light 2155. Based on an experiment conducted by the inventors of the present invention, when an operating voltage, which realizes a complete blocking mode and a complete transmission mode, is applied to the liquid crystal layer 134, transmittance of the reaction light 2155 can be controlled without actual thermalization of the liquid crystal layer 134.

More specifically, in this experiment, UV light with a wavelength of 350 nm was incident to a plurality of LCDs, from which polarizers are removed, at radiant flux per unit area of 160 mW/cm², and the polarizers were attached again to the LCDs to which the UV light was incident. Then, a voltage-transmittance characteristic of the LCDs to which the UV light was incident was measured using an Ultraviolet-Visible spectrophotometer. The time taken for irradiating UV to each LCD was two, eight, and eighty minutes, respectively.

According to the results of the experiment, transmittance of the LCDs in a voltage range of approximately 2.5-3 V (hereinafter, referred to as a complete blocking mode) is approximately 0 and is not related to the time for which UV light is incident and a voltage change within the range. In addition, in a voltage range of approximately 0-1.5 V (hereinafter, referred to as a complete transmission mode), transmittance is reduced from approximately 0.5 to 0.35. However, the transmittance is restored to approximately 0.42 as time passes and is not related to a voltage change within the range. Unlike this, in a voltage range of 1.5-2.5 V (hereinafter, referred to as a grey scale mode), the transmittance is rapidly changed according to a change in applied voltage.

For LCDs having the purpose of realizing various colors, stability of the grey scale mode must be satisfied as an important technical requirement. However, since photochemical synthesis reaction is determined according to whether the reaction light 2155 is incident to the substrate 2120, it is sufficient that the LCD 140 has a voltage condition for completely blocking the reaction light 2155 and for the reaction light 2155 to be stably transmitted through the LCD 140. From this point of view, an important technical requirement for photochemical synthesis is stability of the complete blocking mode, instead of stability of the grey scale mode. As a result of the experiment conducted by the inventors, the LCD according to the present invention satisfies such technical requirement.

Meanwhile, transmittance in the grey scale mode varies according to the applied voltage and the time for which UV light is incident, as described above, and thus intensity of light that is incident to the substrate 2120 cannot be stably controlled. However, in the complete transmission mode, transmittance is not affected by the applied voltage and the time for which UV light is incident, as described above, and thus intensity of the reaction light can be stably controlled. Accordingly, the LCD 140 according to the current embodiment of the present invention can be configured to operate in an operating voltage range which realizes the complete blocking mode and complete transmission mode. Here, the range of operating voltage for the complete blocking mode and complete transmission mode varies according to types and structure of the liquid crystal materials, and the structure of the used LCD.

Moreover, in the technical field of LCDs, various technologies for securing a wide viewing angle have been suggested. However, the wide viewing angle makes spatial confinement of the transmission region difficult. Thus, the LCD according to the present invention is configured to have a narrow viewing angle (for example, approximately 0 to 45 degrees). More preferably, the viewing angle may be in the range of approximately 0 to 10 degrees. From this point of view, the LCD according to the present invention is the same as a conventional LCD in terms of the operating method thereof and is different from a conventional LCD in terms of the configuration thereof.

Thus, the liquid crystal layer 134 and the types and structure of the alignment layers are configured to realize a narrow viewing angle.

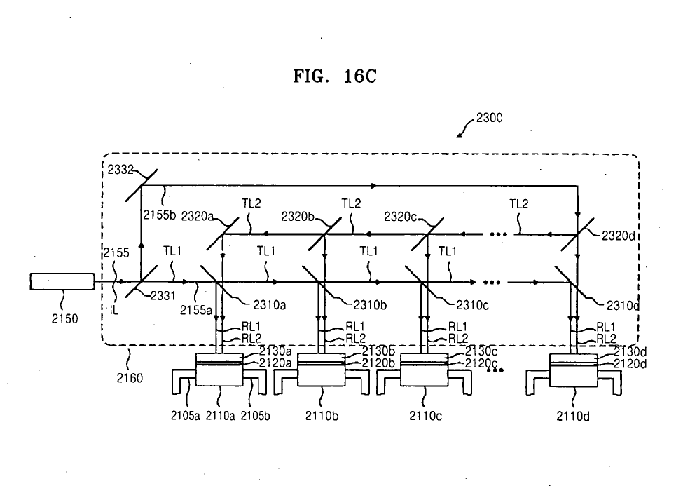

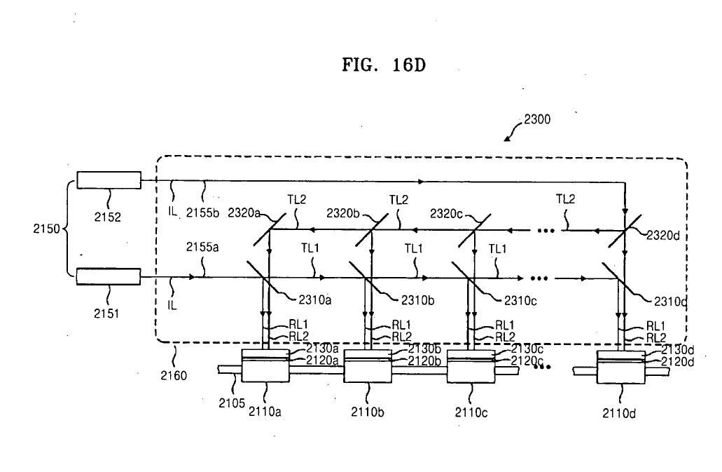

FIG. 14 is a diagram of a photochemical synthesis apparatus according to another embodiment of the present invention and FIG. 15 is a diagram for explaining a reaction light controller 2160 according to an embodiment of the present invention. The photochemical synthesis apparatus of FIG. 14 is similar to the photochemical synthesis apparatus 2100 of FIG. 12 described above, except for inclusion of the reaction light controller 2160. Accordingly, elements common to both apparatuses will not be described again.

Referring to FIGS. 14 and 15, the reaction light controller 2160 is interposed between the light source 2150 and the transmission region controller 2130 and is configured to control an optical characteristic and optical path of the reaction light 2155. For example, the reaction light controller 2160 may be configured to control at least one of a progressing direction, intensity, and an incident angle to the substrate 2120 of the reaction light 2155. Here, at least one of a plurality of various optical components, such as a convex lens, concave lens, mirror, attenuator, prism, diffraction grids, and optical splitter, can be used.

In order to improve reliability of an analyzing chip, material layers 2200 each having a different stacking structure are required to be partially formed in each of analyzing regions. Accordingly, the reaction light controller 2160 may be configured for the reaction light 2155 generated in the light source 2150 to be substantially vertically incident to the upper surface of the substrate 2120. When the reaction light 2155 is vertically incident to the substrate 2120, the area A2 of the region in which the material layer 2200 is formed is substantially equal to the area A1 of the corresponding pixel PX, as illustrated in FIG. 15, so that the material layer 2200 can be partially formed in each of the analyzing regions. More specifically, as illustrated in FIG. 14, the reaction light controller 2160 may include a concave lens 161 and a convex lens 2162, wherein the concave lens 161 widens the cross section of the reaction light 2155 generated in the light source 2150 to form widened reaction light 156 which is transmitted through the convex lens 2162 to form parallel light 2157. Here, the reaction light controller 2160 may further include at least one mirror 2163 which changes the transmission path of the reaction light 2155.

Meanwhile, when a gap between the analyzing regions is sufficiently large, the reaction light 2155 may not be required to have a specific incident angle. In addition to this, according to another embodiment of the present invention, the area of the region where the material layer 2200 is formed may be less than the area of the corresponding pixel. Thus, the reaction light controller 2160 may be configured to have a cross section that gradually narrows in the direction of the reaction light 2155. The technical requirement relating to the incident angle of the reaction light 2155 may be satisfied by controlling the configuration and arrangement of optical components forming the reaction light controller 2160.

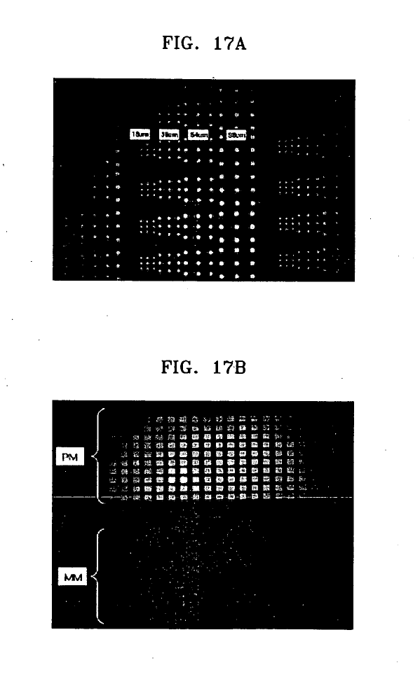

FIGS. 16A through 16D are diagrams of photochemical synthesis apparatuses 2300 according to other embodiments of the present invention. In these embodiments, photochemical synthesis is simultaneously performed in a plurality of reaction chambers and the light source, reaction chambers and the transmission region controller may be the same as those described above. Thus, elements common to the photochemical synthesis apparatuses 2300 of FIGS. 16 A through 16D and the photochemical synthesis apparatuses described above will not be described again.

Referring to FIGS. 16A through 16D, the photochemical synthesis apparatus 300 according to these embodiments includes at least one light source 2150 generating the reaction light 2155, a plurality of reaction chambers 2110a, 2110b, 2110c, . . . , and 2110d through which source materials, similar to the source materials 2115 of FIG. 12, inflow/outflow, and a plurality of substrates 2120a, 2120b, 2120c, . . . , and 2120d interposed between the light source 2150 and the reaction chambers 2110a, 2110b, 2110c, . . . , and 2110d. Here, the substrates 2120a, 2120b, 2120c, . . . , and 2120d are loaded one by one onto the upper surfaces of the reaction chambers 2110a, 2110b, 2110c, . . . , and 2110d, respectively, so as to contact the source materials supplied to the reaction chambers 2110a, 2110b, 2110c, and 2110d. Also, the reaction light controller 2160 is disposed between the light source 2150 and the substrates 2120a, 2120b, 2120c, . . . , and 2120d and transmission region controllers 2130a, 2130b, 2130c, . . . , and 2130d are disposed between the reaction light controller 2160 and the substrates 2120a, 2120b, 2120c, . . . , and 2120d.

Each of the reaction light controllers 2160 of FIGS. 16A and 1B includes optical splitters 2310a, 2310b, 2310c, . . . , and 2310d which split the incident reaction light 2155 into beams progressing in different directions.

According to the current embodiments, the optical splitters 2310a, 2310b, 2310c, . . . , and 2310d may be a half mirror which splits incident light IL respectively into reflection light RL and transmission light TL. The reflection light RL or transmission light TL which passes through a predetermined optical splitter (for example, the optical splitter 2310a) is incident to another optical splitter (for example, the optical splitter 2310b) and is split again into the reflection light RL and transmission light TL. At least one of the reflection light RL and transmission light TL is incident to one of the corresponding transmission region controllers 2130a, 2130b, 2130c, . . . , and 2130d. In FIGS. 16A and 16B, the reflection light RL is illustrated as being incident to the substrates 2120a, 2120b, 2120c, . . . , and 2120d for convenience. However, it is obvious to one of ordinary skill in the art to configure the reaction light controller 2160 for the transmission light TL to be incident to the substrates 2120a, 2120b, 2120c, . . . , and 2120d.

According to such configuration, one reaction light 2155 is used to simultaneously perform photochemical synthesis in the reaction chambers 2110a, 2110b, 2110c, . . . , and 2110d so that productivity of the product can be improved. Moreover, as illustrated in FIGS. 16B and 16D, a pipe 105 for inflow/outflow of the source materials may be disposed to connect the reaction chambers 2110a, 2110b, 2110c, . . . , and 2110d. In this case, unnecessary consumption of the source materials can be reduced and thus product manufacturing costs can be reduced. However, as illustrated in FIGS. 16A and 16C, a pipe 2105a for inflow of the source materials and a pipe 2105b for outflow of the source materials may be separately connected to each of the reaction chambers 2110a, 2110b, 2110c, . . . , and 2110d.

Meanwhile, according to the current embodiments of the present invention, the reaction light controller 2160 may be configured to uniformly form an optical characteristic of light incident to the transmission region controllers 2130a, 2130b, 2130c, . . . , and 2130d.

For example, as illustrated in FIG. 16B, attenuators 2350a, 2350b, 2350c, . . . and 2350d capable of reducing intensity of incident light can be disposed between the optical splitters 2310a, 2310b, 2310c, . . . , and 2310d and corresponding transmission region controllers 2130a, 2130b, 2130c, . . . , and 2130d. The attenuation of the attenuators 2350a, 2350b, 2350c, and 2350d may be reduced if the number of optical splitters arranged on the progressing path increases. When the attenuation of the attenuators 2350a, 2350b, 2350c, . . . , and 2350d is controlled, intensity of light incident to the transmission region controllers 2130a, 2130b, 2130c, . . . , and 2130d may be uniform, regardless of location of the transmission region controllers 2130a, 2130b, 2130c, . . . , and 2130d.

According to another embodiment of the present invention, as illustrated in FIG. 16C, the reaction light controller 2160 may include a first optical splitter 2331 and a mirror 2332, wherein the first optical splitter 2331 splits the reaction light 2155 into first reaction light 2155a and second reaction light 2155b progressing in different directions respectively, and the mirror 2332 changes a progressing path of the second reaction light 2155b. Here, the second reaction light 2155b is split by other optical splitters 2320a, 2320b, 2320c, . . . , and 2320d and is incident to the transmission region controllers 2130a, 2130b, 2130c, . . . , and 2130d. Here, when the progressing paths of the first reaction light 2155a and the second reaction light 2155b are configured to be opposite to each other, intensity of light incident to arbitrary transmission region controllers 2130a, 2130b, 2130c, . . . , and 2130d are substantially the same, because, according to such configuration, the sum total of the number of the optical splitters 2310a, 2310b, 2310c, . . . , and 2310d, and 2320a, 2320b, 2320c, . . . , and 2320d disposed on the progressing paths of the first and second reaction lights 2155a and 2155b are the same as each other, regardless of locations of the transmission region controllers 2130a, 2130b, 2130c, . . . , and 2130d.

According to another embodiment of the present invention, as illustrated in FIG. 16D, the photochemical synthesis apparatus 2300 may include a first light source 2151 for generating a first reaction light 2155a and a second light source 2152 for generating the second reaction light 2155b. The number of light sources may be two or more and reaction lights generated from each of the light sources may have the same optical characteristic.

Here, as described with reference to FIG. 16C, the reaction light controller 2160 may be configured for the first and second reaction lights 2155a and 2155b to progress in different directions respectively. In this case, as described above, the sum total of the number of optical splitters 2310a, 2310b, 2310c, . . . , and 2310d, and the number of 2320a, 2320b, 2320c, . . . , and 2320d disposed on the progressing paths of the first and second reaction lights 2155a and 2155b are the same as each other, regardless of locations of the transmission region controllers 2130a, 2130b, 2130c, . . . , and 2130d so that intensity of light incident to the transmission region controllers 2130a, 2130b, 2130c, . . . , and 2130d are substantially the same Meanwhile, according to the current embodiments of the present invention, at least one of a plurality of various optical components such as a convex lens, concave lens, mirror, attenuator, prism, diffraction grids, and optical splitter, can be disposed in the optical splitters 2310a, 2310b, 2310c, . . . , and 2310d, and 2320a, 2320b, 2320c, . . . , and 2320d or between the attenuators 2350a, 2350b, 2350c, . . . and 2350d and the transmission region controllers 2130a, 2130b, 2130c, . . . , and 2130d.

Such optical components, as described above with reference to FIGS. 3 and 4, can control at least one of the progressing direction, intensity, and incident angle to the substrates 2120a, 2120b, 2120c, . . . , and 2120d of the reaction light 2155.

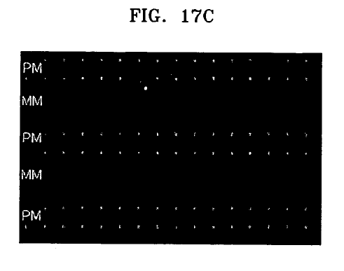

FIGS. 17A through 17C are photographic images of gene diagnostic chips manufactured using a photochemical synthesis apparatus according to the present invention.

More specifically, FIG. 17A is a photographic image showing a DNA microarray which forms a DNA monomer (more specifically, thymine dT) on a substrate using the photochemical synthesis apparatus described above. Here, the transmission region controller used in synthesis is a LCD and a transmittance difference in each region is realized using a complete blocking mode or a complete transmission mode. The formed thymine dT molecules are labeled using Cy3 fluorescence molecules so as to be photographed and the DNA monomers are formed to have diameters of 18 um, 36 um, 54 um, and 98 um.

In FIG. 17B, type 16 probe DNA from among human papilloma virus is synthesized using a photochemical synthesis apparatus according to the present invention and then is hybridized with a virus extracted from the cervix of a real patient. Then, the result is photographed using a scanner. In a perfect match array PM, type 16 probe DNA CAT TAT GTG CTG CCA TAT CTA TTTT: 25mer in human papilloma virus is synthesized. In a mismatch array MM, as illustrated, 1 base mismatch DNA CAT TAT GTG ATG CCA TAT CTA TTTT: 25mer is synthesized. As in FIG. 17B, hybridization occurs only in a perfect match array PM and does not occur in a mismatch array MM.

FIG. 17C is a photographic image of the result obtained from a microarray in which a size of spots thereof in each of the analyzing regions is formed smaller than that of illustrated in FIG. 17B. The region excluding the perfect match array PM and the mismatch array MM is a background region in which the pixels of the LCD used as the transmission region controller 2130 are not turned on during synthesis. The number of measured photons is 635, 200, and 180 in the perfect match array PM, mismatch array MM, and the background region, respectively. Such a large difference in the number of photons between the perfect match array PM and the mismatch array MM indicates that the gene diagnostic chip manufactured according to the present invention is efficiently operated. In addition, the small difference in the number of photons between the mismatch array MM and the background region indicates that the LCD used can effectively block the reaction light 2155. According to the present invention, the transmission region controller can variably control the location of the regions on which the reaction light is incident. A LCD can be used as the transmission region controller. According to the present invention, the location of the regions on which the reaction light is incident is controlled using a complete blocking mode and complete transmission mode of the LCD.

Moreover, the photochemical synthesis apparatus according to the present invention uses laser light having a high degree of coherence as a light source. Such a high degree of coherence enables the transmission region defined by the transmission region controller to be transcribed onto the substrate without substantial change in the area thereof. Thus, a change in the cross section of the reaction light which may occur while the light is transmitted through the transmission region controller can be reduced. In addition to this, according to the present invention, the transmission region controller has a narrow viewing angle so as to reduce a change in the cross section of the reaction light.

According to the present invention, the reaction light controller, which controls the reaction light, includes optical splitters. The photochemical synthesis can be simultaneously performed in a plurality of reaction chambers using the optical splitters so that the photochemical synthesis apparatus according to the present invention can have high productivity. Here, the transmission region controller can separately control the transmission region of each of a plurality of substrates loaded onto a corresponding one of the reaction chambers and thus a different product can be manufactured in each reaction chamber.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A programmable mask for fabricating a biomolecule array or polymer array, the mask comprising:
a first substrate including a black matrix having openings for incident UV and first pixel electrodes;
a second substrate including thin film transistors for switching pixel regions which correspond to the openings according to applied electric signals and second pixel electrodes connected to drain electrodes of the thin film transistors;
a liquid crystal layer interposed between the first substrate and the second substrate, the liquid crystal layer including liquid crystal whose arrangement can be changed according to electric signals of the thin film transistors so as to selectively transmit light;
a first polarizing plate laminated on one side of the first substrate to polarize UV light;
a second polarizing plate laminated on one side of the second substrate to polarize UV light; and
a lens array layer laminated on one side of the second polarizing plate including lenses which correspond to the pixel regions.

2. The programmable mask of claim 1, further comprising a driving circuit for driving the thin film transistors on the second substrate, the driving circuit being disposed outside the pixel regions.

3. The programmable mask of claim 1, wherein the lens is a hemispherical lens.

4. The programmable mask of claim 1, wherein the lens is a gradient index lens.

5. The programmable mask of claim 1, wherein the polarizing plate has high transmittance with respect to UV light having wavelength of 320-400 nm.

6. The programmable mask of claim 1, wherein the biomolecule is one of nucleic acid and protein.

7. The programmable mask of claim 6, wherein the nucleic acid is selected from the group consisting of DNA, RNA, PNA, LNA, and a hybrid thereof.

8. The programmable mask of claim 6, wherein the protein is selected from the group consisting of enzyme, substrate, antigen, antibody, ligand, aptamer, and receptor.

9. An apparatus for fabricating a biomolecule array or polymer array comprising:
a UV light generator including a UV light source and a lens unit through which UV light irradiated from the UV light source passes;
a programmable mask for fabricating a biomolecule or polymer;
wherein the programmable mask comprises: a first substrate disposed so as to be spaced apart from the UV light generator, the first substrate including a black matrix having openings for incident UV light and first pixel electrodes; a second substrate including thin film transistors for switching pixel regions which correspond to the openings according to applied electric signals and second pixel electrodes connected to drain electrodes of the thin transistors; a liquid crystal layer interposed between the first substrate and the second substrate, the liquid crystal layer including liquid crystal whose arrangement can be changed according electric signals of the thin film transistors so as to selectively transmit light; a first polarizing plate laminated on one side of the first substrate to polarize UV light; a second polarizing plate laminated on one side of the second substrate to polarize UV light;
and a lens array layer laminated on one side of the second polarizing plate including lenses which correspond to the pixel regions;
and
an array forming chamber forming a biomolecule array or polymer array, wherein the array forming chamber is laminated on the programmable mask and includes a sample plate on which the biomolecule or polymer array is formed, and a washing solution and a biomolecule or polymer flow in and out of the array forming layer.

10. The apparatus of claim 9, wherein the UV light source is one of a LED two dimensional array and a laser diode two dimensional array.

11. The apparatus of claim 9, wherein the lens unit of the UV light generator comprises a homogenizer lens unit to make UV light generated by the UV light source uniform, a field lens to concentrate UV light generated by the homogenizer lens unit, and a convex lens to make UV light generated by the field lens parallel.

12. The apparatus of claim 9, wherein the focal point of the lens of the programmable mask is formed on the sample plate where a biomolecule array or polymer array is formed.

13. The apparatus of claim 9, wherein the lens of the programmable mask is a hemispherical lens.

14. The apparatus of claim 9, wherein the lens of the programmable mask is a gradient index lens.

15. A programmable mask for fabricating a biomolecule array or polymer array comprising:
a first substrate including a black matrix having openings and first pixel electrodes;
a second substrate including thin film transistors for switching pixel regions which correspond to the openings according to applied electric signals and second pixel electrodes connected to drain electrodes of the thin film transistors;
a liquid crystal layer interposed between the first substrate and the second substrate, the liquid crystal layer including liquid crystal whose arrangement can be changed according to electric signals of the thin film transistors so as to selectively transmit light;
a first polarizing plate laminated on one side of the first substrate to polarize UV light; and
a second polarizing plate laminated on one side of the second substrate including a polarizing layer and a biomolecule or polymer fixed layer.

16. The programmable mask of claim 15, wherein the second polarizing plate comprising the polarizing layer, protecting layers laminated on both sides of the polarizing layer, and a biomolecule or polymer fixed layer having a hydrophilic surface on which a biomolecule or polymer can be fixed.

17. The programmable mask of claim 15, wherein the second polarizing plate can be attached to and detached from the second substrate.

18. The programmable mask of claim 15, further comprising a driving circuit for driving the thin film transistors on the second substrate, the driving circuit being disposed outside the pixel regions.

19. The programmable mask of claim 15, wherein the polarizing plate has high transmittance with respect to UV light having wavelength of 320-400 nm.

20. An apparatus for fabricating a biomolecule array or polymer array comprising:
a UV light generator including a UV light source and a lens unit through which UV light irradiated from the UV light source passes;
a programmable mask for fabricating a biomolecule or polymer;
wherein the programmable mask comprises: a first substrate disposed so as to be spaced apart from the UV light generator, the first substrate including a black matrix having openings and first pixel electrodes; a second substrate including thin film transistors for switching pixel regions which correspond to the openings according to applied electric signals and second pixel electrodes connected to drain electrodes of the thin transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate to polarize UV light; and a second polarizing plate laminated on one side of the second substrate to polarize UV light including a polarizing layer and a biomolecule or polymer fixed layer;
and
an array forming chamber forming a biomolecule array or polymer array, wherein the array forming chamber is disposed on the lower part of the second polarizing plate, and a washing solution and a biomolecule or polymer flow in and out of the array forming layer.

21. The apparatus of claim 20, wherein the UV light source is one of a LED two dimensional array and a laser diode two dimensional array.

22. The apparatus of claim 20, wherein the lens unit of the UV light generator comprises a homogenizer lens unit to make UV light generated from the UV light source uniform, a field lens to concentrate UV light generated from the homogenizer lens unit, and a convex lens to make UV light generated by the field lens parallel.

23. The apparatus of claim 20, wherein the second polarizing plate comprising the polarizing layer, protecting layers laminated on both sides of the polarizing layer, and the biomolecule or polymer fixed layer having a hydrophilic surface on which a biomolecule or polymer can be fixed.

24. The apparatus of claim 20, wherein the second polarizing plate can be attached to and detached from the second substrate.

25. An apparatus for fabricating a biomolecule array or polymer array comprising:
a UV light generator including a UV light source and a lens unit, wherein UV light irradiated from the UV light source is passed through the lens unit;
a programmable mask;
wherein the programmable mask comprises: a first substrate disposed so as to be spaced apart from the UV light generator to have a predetermined angle with a propagation path of UV light generated by the UV light generator, the first substrate including a black matrix having openings and first pixel electrodes; a second substrate including thin film transistors for switching pixel regions which correspond to the openings according to applied electric signals, second pixel electrodes connected to drain electrodes of the thin transistors, and reflection layers for reflecting incident UV; a liquid crystal layer interposed between the first substrate and the second substrate, the liquid crystal layer including liquid crystal whose arrangement can be changed according to electric signals of the thin film transistors so as to selectively transmit light;
and
an array forming chamber forming a biomolecule array or polymer array, wherein the array forming chamber is spaced apart from the programmable mask to have a right angle to the UV light path reflected from the programmable mask and includes a sample plate on which the biomolecule or polymer array is formed, and a washing solution and a biomolecule or polymer flow in and out of the array forming layer.

26. The apparatus of claim 25, wherein the UV light source is one of a LED two dimensional array and a laser diode two dimensional array.

27. The apparatus of claim 25, wherein the lens unit of the UV light generator comprises a homogenizer lens unit to make UV light generated from the UV light source uniform, a field lens to concentrate UV light generated from the homogenizer lens unit, and a convex lens to make UV light generated from the field lens parallel.

28. A method of fabricating a biomolecule array or polymer array using a programmable mask for fabricating a biomolecule array or polymer array, wherein the programmable mask comprises: a first substrate including a black matrix having openings and first pixel electrodes; a second substrate including thin film transistors for switching pixel regions which correspond to the openings according to applied electric signals and second pixel electrodes connected to drain electrodes of the thin film transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate; a second polarizing plate laminated on one side of the second substrate; and a lens array layer laminated on one side of the second polarizing plate including lenses which correspond to the pixel regions, the method comprising:
irradiating UV light to selective regions of a sample plate on which molecules having a protecting group are fixed through the programmable mask; and
flowing a solution containing biomolecule or polymer monomer, required to fix to the molecule.

29. A method of fabricating a biomolecule array or polymer array using a programmable mask for fabricating a biomolecule array or polymer array, wherein the programmable mask comprises: a first substrate including a black matrix having openings and first pixel electrodes; a second substrate including thin film transistors for switching pixel regions which correspond to the openings according to applied electric signals and second pixel electrodes connected to drain electrodes of the thin film transistors; a liquid crystal layer interposed between the first substrate and the second substrate, the liquid crystal layer including liquid crystal whose arrangement can be changed according to electric signals of the thin film transistors so as to selectively transmit light; a first polarizing plate laminated on one side of the first substrate; and a second polarizing plate laminated on one side of the second substrate including a polarizing layer and a biomolecule or polymer fixed layer, the method comprising:
irradiating UV light to selective regions of a sample plate on which molecules having a protecting group are fixed through the programmable mask; and
flowing a solution containing biomolecule or polymer monomer, required to fix to the molecule.

30. A photochemical synthesis apparatus for selectively forming source materials in a predetermined region on a substrate, the apparatus comprising:
a reaction chamber onto which the substrate is loaded and into which reaction molecules forming the source materials are supplied;
a light source providing reaction light, the light source being disposed above the substrate; and
a transmission region controller variably controlling regions through which the reaction light can be transmitted to the substrate, the transmission region controller being disposed between the light source and the substrate,
wherein the reaction light comprises laser light having a high degree of coherence.

31. The apparatus of claim 30, wherein the reaction light has a wavelength which induces the source materials to be attached to the substrate.

32. The apparatus of claim 30, wherein the source materials comprise at least one of DNA monomers for analyzing gene expression and single nucleotide polymorphism, an activator solution, amino acids and proteins for protein synthesis, monomers and polymers for polymer synthesis, and a cleaning solution.

33. The apparatus of claim 32, wherein the source materials comprise a protecting molecule capable of being photo-deprotected by the reaction light.

34. The apparatus of claim 30, wherein the transmission region controller comprises transmission regions that are two dimensionally arranged, the transmittance of the transmission regions being controlled in response to an electrical signal.

35. The apparatus of claim 30, wherein the transmission region controller comprises a liquid crystal display (LCD) using a voltage-transmittance characteristic of a liquid crystal layer, the LCD comprising: pixels that are two-dimensionally arranged; a pixel controller generating an operating voltage for controlling transmittance of the pixels; and wirings connecting to the pixels and transmitting the operating voltage to the pixels.

36. The apparatus of claim 35, wherein the source materials comprises at least one of a plurality of DNA monomers, the reaction light comprises laser light having a wavelength of a UV band and a high degree of coherence, and the operating voltage is selected to prevent the LCD being damaged by the laser light having a wavelength of a UV band.

37. The apparatus of claim 36, wherein the operating voltage is selected for the liquid crystal layer to be operated in a complete transmission mode and a complete blocking mode.

38. The apparatus of claim 30, wherein the transmission region controller is configured to have a viewing angle of approximately 0-10 degrees.

39. The apparatus of claim 30, further comprising a reaction light controller for controlling at least one of progressing direction, intensity, and incident angle to the substrate of the reaction light, the reaction light controller being disposed between the light source and the substrate.

40. The apparatus of claim 30, wherein the reaction light controller is configured for the reaction light to form parallel light which is substantially vertically incident to the upper surface of the substrate.

41. A photochemical synthesis apparatus for selectively forming source materials in a predetermined region on a substrate, the apparatus comprising:
at least one light source generating reaction light;
a plurality of reaction chambers onto which a plurality of substrates are respectively loaded;
a reaction light controller guiding the reaction light to the substrates; and
a transmission region controller variably controlling regions through which the reaction light can be transmitted to the substrates, the transmission region controller being disposed between the reaction light controller and the substrates,
wherein the reaction light controller comprises a plurality of optical splitters splitting the reaction light so as to be provided to the plurality of substrates.

42. The apparatus of claim 41, wherein the reaction light controller comprises a plurality of half mirrors which split the reaction light into transmission light and reflection light, each progressing in a direction parallel to and perpendicular to the incident light, the half mirrors being configured for the transmission light or reflection light transmitted by the light source or another of the half mirrors to be transmitted to the substrate or another of the half mirrors.

43. The apparatus of claim 41, wherein the reaction light controller is configured for intensity of the reaction light incident to the substrates to be substantially the same.

44. The apparatus of claim 43, wherein the optical splitters are disposed to correspond to the substrates, respectively, and the reaction light controller further comprises one or more attenuators disposed between at least one of the substrates and the corresponding optical splitters.

45. The apparatus of claim 44, wherein the one or more attenuators disposed between the substrate and corresponding optical splitter is configured to have reduced attenuation if the number of optical splitters arranged on the progressing path of the reaction light incident to the substrates is increased.

46. The apparatus of claim 43, wherein the reaction light controller is configured to form a path of a first reaction light incident to the substrates in a first order and a path of a second light reaction incident to the substrates in a second order opposite to the first order, between the reaction light and the substrates.

47. The apparatus of claim 41, wherein the reaction light comprises laser light having a wavelength which induces the source materials to be attached to the substrates, and a high degree of coherence.

48. The apparatus of claim 41, wherein the source materials comprise at least one of DNA monomers for analyzing gene expression and single nucleotide polymorphism, an activator solution, amino acids and proteins for protein synthesis, monomers and polymers for polymer synthesis, and a cleaning solution.

49. The apparatus of claim 48, wherein the source materials comprise a protecting molecule capable of being photo-deprotected by the reaction light.

50. The apparatus of claim 48, wherein the transmission region controller comprises transmission regions that are two dimensionally arranged, the transmittance of the transmission regions being controlled in response to an electrical signal.

51. The apparatus of claim 50, wherein the transmission region controller comprises a liquid crystal display (LCD) using a voltage-transmittance characteristic of a liquid crystal layer, the LCD comprising: pixels that are two-dimensionally arranged; and a pixel controller generating an operating voltage for controlling transmittance of the pixels, the pixel controller controlling transmittance of the pixels according to location of the pixels and the types of the source materials applied to the reaction chambers, in order for the source materials to be formed as different stacking structures on the substrates, respectively.

52. The apparatus of claim 51, wherein the source materials comprise at least one of a plurality of DNA monomers, the reaction light comprises laser light having a wavelength of a UV band and a high degree of coherence, and the operating voltage is selected to prevent the LCD being damaged by the laser light having a wavelength of a UV band.

53. The apparatus of claim 52, wherein the operating voltage is selected for the liquid crystal layer to be operated in a complete transmission mode and a complete blocking mode.

54. The apparatus of claim 41, wherein the reaction light controller is configured for the reaction light to form parallel light which is substantially vertically incident to the upper surface of the substrate.
